(19) United States
(12) Patent Application Publication
(10) Pub. No.: US 2016/0239651 A1
(43) Pub. Date: Aug. 18, 2016

(54) METHOD OF CONTROLLING AN ELECTRONIC DEVICE TO OPERATE USING A MOBILE TERMINAL AND THE MOBILE TERMINAL

(71) Applicant: GOLDEN VAST MACAO COMMERCIAL OFFSHORE LIMITED, Macau (CN)

(72) Inventor: KwokFong WONG, HongKong (CN)

(21) Appl. No.: 15/019,388

(22) Filed: Feb. 9, 2016

(30) Foreign Application Priority Data
Feb. 15, 2015 (CN) 201510083752.3

(51) Int. Cl. G06F 21/32; H04W 12/06; H04W 12/08

(52) U.S. Cl. CPC G06F 21/32; H04W 12/08; H04W 12/06

(57) ABSTRACT

The invention provides a method of controlling an electronic device to operate using a mobile terminal and the mobile terminal. Wherein the method comprises obtaining a confirmation message that a user has been authenticated sent by a biological recognition device, determining that the moving direction of a second fingerprint image on a touch screen of the mobile terminal is consistent with a predetermined direction; and sending an operation instruction to the electronic device so that the electronic device operates according to the operation instruction. As compared with the authentication methods of the prior art, in the method of controlling an electronic device to operate using a mobile terminal and the mobile terminal of the invention, the user authentication is more safe, and thus the course of mobile terminal controlling the electronic device to operate is more safe.

### FIELD OF THE INVENTION

The invention relates to the filed of intelligent home, and more particularly to a method of controlling an electronic device to operate using a mobile terminal and the mobile terminal.

### DESCRIPTION OF THE RELATED ART

In ordinary families, usually there are various electronic devices, for example, a computer and a household appliance such as a television, a refrigerator, a washing machine, a microwave oven, a water heater etc. Taking the household appliances as an example, in the traditional life, a user approaches to and manually operates these household appliances to achieve their functionalities. With the development of intelligent home, it is increasingly common that a mobile terminal, such as a mobile phone, a tablet PC and a notebook, is used for remotely controlling the household appliances to correspondingly operate.

In the prior art, when an electronic device is controlled to correspondingly operate by a mobile terminal, firstly a user needs to be authenticated, and only the authenticated user can control the electronic device to correspondingly operate by a mobile terminal. However, the existing methods of user authentication are so simple that the security of authentication is poor.

### SUMMARY OF THE INVENTION

In order to solve the above technical problem, the embodiments of the invention provide a method of controlling an electronic device to operate using a mobile terminal and the mobile terminal, to increase the security of user authentication for an electronic device, thereby further ensuring the security of the mobile terminal controlling the electronic device to operate.

Thus, in one aspect, one embodiment of the invention provides a method of controlling an electronic device to operate using a mobile terminal and the mobile terminal, the method comprises:
obtaining a confirmation message that a user has been authenticated sent by a biological recognition device, wherein the confirmation message is generated after the biological recognition device confirms that a first fingerprint image of the user is consistent with an authenticated image;
determining that the moving direction of a second fingerprint image on a touch screen of the mobile terminal is consistent with a predetermined direction; and
sending an operation instruction to the electronic device so that the electronic device operates according to the operation instruction.

Preferably, before determining that the moving direction of the second fingerprint image on the touch screen of the mobile terminal is consistent with the predetermined direction, the method also comprises determining that the second fingerprint image is consistent with a preset image.

Preferably, after determining that the moving direction of the second fingerprint image on the touch screen of the mobile terminal is consistent with the predetermined direction, the method also comprises determining that the second fingerprint image moves into a predetermined area on the touch screen.

Preferably, before obtaining the confirmation message that a user has been authenticated sent by the biological recognition device, the method also comprises sending a request message of user identity authentication to the biological recognition device.

Preferably, sending an operation instruction to the electronic device comprises sending the operation instruction to the electronic device via wireless communication.

In another aspect, one embodiment of the invention also provides a mobile terminal, comprising:
an obtaining unit for obtaining a confirmation message that a user has been authenticated sent by a biological recognition device, wherein the confirmation message is generated after the biological recognition device confirms that a first fingerprint image of the user is consistent with an authenticated image;
a first determining unit for determining that the moving direction of a second fingerprint image on a touch screen of the mobile terminal is consistent with a predetermined direction; and
a first sending unit for sending an operation instruction to the electronic device so that the electronic device operates according to the operation instruction.

Preferably, the mobile terminal also comprises:
a second determining unit for determining that the second fingerprint image is consistent with a preset image.

Preferably, the mobile terminal also comprises:
a third determining unit for determining that the second fingerprint image moves into a predetermined area on the touch screen.

Preferably, the mobile terminal also comprises:
a second sending unit for sending a request message of user identity authentication to the biological recognition device.

Preferably, the mobile terminal also comprises:
a wireless communication module for sending an operation instruction to the electronic device.

In the embodiments of the invention, a user is authenticated as follows: firstly a confirmation message that a user has been authenticated sent by a biological recognition device is obtained, and secondly it is determined that the moving direction of a second fingerprint image on a touch screen of the mobile terminal is consistent with a predetermined direction. Thus, a user is authenticated by means of the combination of a biological recognition device and a mobile terminal with a fingerprint image and the moving direction, and the authentication is successful when the two aspects are completed. As compared with the authentication method of the prior art, in the method of controlling an electronic device to operate using a mobile terminal provided by the embodiment of the invention, the user authentication method is more safe, and the course of a mobile terminal controlling the electronic device to operate is more safe.

### BRIEF DESCRIPTION OF THE DRAWINGS

In order to illustrate more clearly the technical solutions of the embodiments of the invention, the drawings used in the embodiments will be described simply hereinafter. Obviously, the drawings are given only by way of example, and for a person skilled in the art, other equivalent drawings can be obtained according to these drawings without any creative work.

FIG. 1 is a flow chart of a method of controlling an electronic device to operate using a mobile terminal according one embodiment of the invention.

FIG. 2 is a schematic drawing of a mobile terminal according to one embodiment of the invention.

### DETAILED DESCRIPTION OF THE INVENTION

In order to make the object, technical solutions and advantages of the invention more clearly, the technical solutions of the embodiments of the invention will be described hereinafter fully and clearly in connection with drawings. It is obvious, that the embodiments to be described just are parts of the embodiments of the invention, instead of all of the embodiments. Based on the embodiments of the invention, the other embodiments obtained by one skilled in the art without any creative work are covered by the protection scope of the invention.

With the development of intelligent home, a mobile terminal, such as a mobile phone, a tablet PC and a notebook, can communicate with an electronic device equipped with a communication module within the same local area network, for example, a refrigerator, a washing machine, an air conditioner, a television, a microwave oven, a water heater etc. The communication module in the terminal device may be a wire or wireless communication module.

When an electronic device is controlled to correspondingly operate by a mobile terminal, firstly a user is authenticated, and the subsequent operation is performed after the authentication is successful, and the course of user authentication can be achieved by the mobile terminal.

In the prior art, the user authentication of the electronic device is simple and the security of authentication process can not be ensured, and thus the security of the mobile terminal controlling the electronic device to operate can not be ensured.

Therefore, the following technical solutions are provided by the embodiments of the invention.

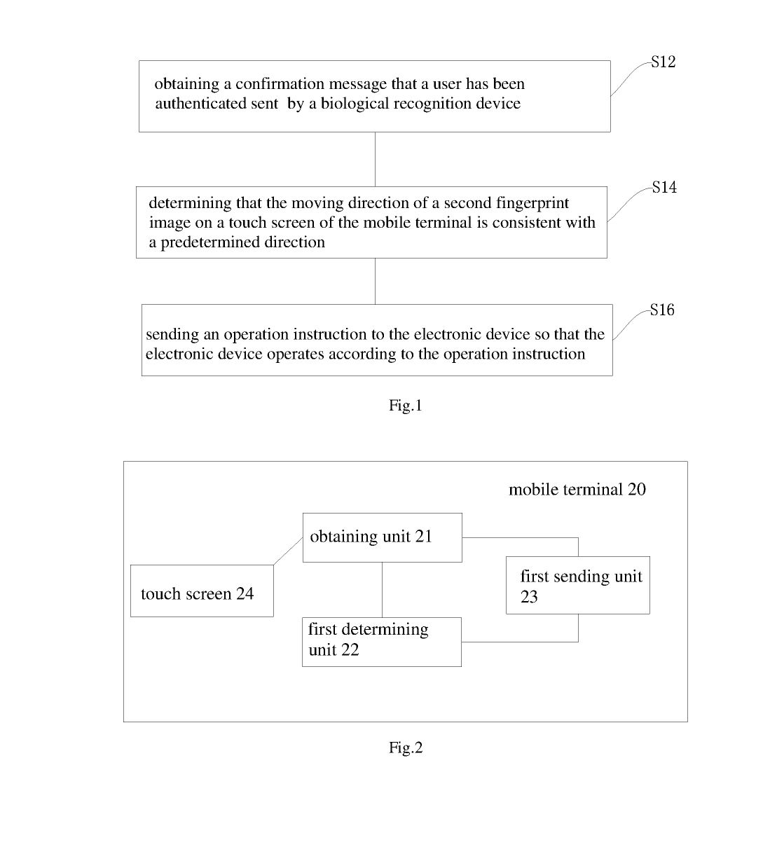

As shown in FIG. 1, one embodiment of the invention provides a method of controlling an electronic device to operate by a mobile terminal, the mobile terminal may be a mobile phone, a tablet PC, a notebook, a wearable device (for example. a device equipped with a communication module, such as a smart band, a smart watch and a smart strap) etc. Herein, the electronic device may be selected from one or more of a refrigerator, a washing machine, an air conditioner, a television, a microwave oven, a water heater etc. The method comprises the following steps:

Step S12: obtaining a confirmation message that a user has been authenticated sent by a biological recognition device, wherein the confirmation message is generated after the biological recognition device determines that a first fingerprint image of the user is consistent with an authenticated image.

The biological recognition device may be for example a fingerprint identifier, or other intelligent devices which can identify user's fingerprint image. The biological recognition device may be internally installed in the mobile terminal, also may be an independently peripheral device of the mobile terminal, or may be internally installed in other mobile terminals and can communicate with the mobile terminal.

The first fingerprint image of the user may be a fingerprint image input in the biological recognition device by the user. An authenticated image can be previously stored within the biological recognition device, and this authenticated image may be a fingerprint image. If the first fingerprint image input in the biological recognition device by a user is consistent with the authenticated image, then the user authentication is successful, next, the biological recognition device will generate a confirmation message that a user has been authenticated and sends the confirmation message to the mobile terminal.

Step S14: determining that the moving direction of a second fingerprint image on a touch screen of the mobile terminal is consistent with a predetermined direction.

The mobile terminal usually has a touch screen, and a user can input operating information to the mobile terminal by means of the touch screen. In some embodiments, the mobile terminal can firstly detect whether a user fingerprint is input in a predetermined location of the touch screen, if yes, then a second fingerprint image corresponding to the user fingerprint is obtained. For example, in a home network, the relevant information of a washing machine is registered in a mobile phone, and a pattern corresponding to the washing machine can be displayed in a certain location on the touch screen of the mobile phone. Now, firstly the mobile phone can detect whether a user fingerprint is input in the location of the pattern on the touch screen, if yes, then it indicates that the user attempts to operate the washing machine by the mobile phone, and the fingerprint image corresponding to the fingerprint input can be obtained. Wherein the predetermined location on the touch screen may be any location on the touch screen, for example, the predetermined location may be in an upper left portion, a lower right portion, an upper right portion, a lower left portion or a central portion of the touch screen.

Wherein the user can set a predetermined direction of a fingerprint image in a mobile terminal, if the moving direction of the second fingerprint image on the touch screen is consistent with the predetermined direction then the authentication is successful, and if not consistent then authentication is unsuccessful.

Wherein the predetermined direction may be from left to right, right to left, up to down, down to up, or along the direction of a diagonal line, broken line or curve line etc.

In some embodiments, in order to further improve the security of the authentication process, after the step S14 it is determined whether the second fingerprint image is moved into the predetermined area on the touch screen, if yes then the authentication is successful, otherwise the authentication is unsuccessful. For example, the predetermined area may be located in the right edge of the touch screen. If the second fingerprint image is moved from an initial location to the right edge of the touch screen then the authentication is successful, otherwise the authentication is unsuccessful.

It is noted that, the second fingerprint image and the above fingerprint image can be the same or different. For example, if the fingerprint identifier in the step S12 is located within the mobile terminal then the second fingerprint image may be the same as the first fingerprint image. If the fingerprint identifier in the step 12 is provided as an independent peripheral device of the mobile terminal, or located within other mobile terminals and can communicate with this mobile terminal, then the second fingerprint image may be different from the first fingerprint image.

Step S16: sending an operation instruction to the electronic device so that the electronic device operates according to the operation instruction.

Wherein the operation instruction may be reading or obtaining the relevant information of the electronic device, starting the electronic device, suspending the electronic device or closing the electronic device and the like.

Specifically, the mobile terminal can send the operation instruction to the electronic device via wire communication, preferably via wireless communication.

In the embodiments of the invention, a user is authenticated as follows: firstly a confirmation message that a user has been authenticated sent by a biological recognition device is obtained, and secondly it is determined that the moving direction of a second fingerprint image on a touch screen of the mobile terminal is consistent with a predetermined direction. Thus, a user is authenticated by means of the combination of a biological recognition device and a mobile terminal with a fingerprint image and the moving direction, and the authentication is successful when the two aspects are completed. As compared with the authentication method of the prior art, in the method of controlling an electronic device to operate using a mobile terminal provided by the embodiment of the invention, the user authentication method is more safe, and the course of a mobile terminal controlling the electronic device to operate is more safe.

It is noted that, in some embodiments of the invention, in order to further improve the security of authentication, after the step S12 and before the step S14, it is further determined whether the second fingerprint image is consistent with the preset image.

A user can previously store a preset image in a mobile terminal, and the preset image may be a fingerprint image. When the mobile terminal obtains a second fingerprint image input via the touch screen by a user, the second fingerprint image is compared with the preset image. If the second fingerprint image is consistent with the preset image then the sequent authentication step is performed. If the second fingerprint image is not consistent with the preset image then the authentication process is paused.

By means of the above method, it is avoided that an unauthorized user controls the electronic device to operate by the mobile terminal, thereby further improving the security of authentication.

Furthermore, in the embodiment shown in FIG. 1, the following step can be performed before the step S12: sending a request message of user identity authentication to the biological recognition device.

After receiving the instruction of performing identity authentication on the user, the mobile terminal sends a request message of user identity authentication to the biological recognition device, so that the biological recognition device obtains the first fingerprint image of the user and compares the first fingerprint image with the authenticated image. If consistent, a confirmation message that user identity authentication is successful is generated and sent to the mobile terminal.

Furthermore, as shown in FIG. 2, an embodiment of the invention also provides a mobile terminal 20, and a user can control an electronic device to operate by the mobile terminal 20. The mobile terminal 20 may comprise:
an obtaining unit 21 for obtaining a confirmation message that a user has been authenticated sent by a biological recognition device, wherein the confirmation message is generated after the biological recognition device determines that a first fingerprint image of the user is consistent with an authenticated image;
a first determining unit 22 for determining that the moving direction of a second fingerprint image on a touch screen 24 of the mobile terminal is consistent with a predetermined direction; and
a first sending unit 23 for sending an operation instruction to the electronic device so that the electronic device operates according to the operation instruction; and
a touch screen 24.

The biological recognition device may be for example a fingerprint identifier, or other intelligent devices which can identify a user's fingerprint image. The biological recognition device may be internally installed in the mobile terminal, also may be provided as an independent peripheral device of the mobile terminal, or internally installed in other mobile terminals and can communicate with the mobile terminal.

The first fingerprint image of the user may be a fingerprint image input in the biological recognition device by the user. An authenticated image can be previously stored within the biological recognition device, and this authenticated image may be a fingerprint image. If the first fingerprint image input in the biological recognition device by a user is consistent with the authenticated image, then the user authentication is successful, next, the biological recognition device will generate a confirmation message that a user has been authenticated and sends the confirmation message to the mobile terminal.

The mobile terminal usually has a touch screen, and a user can input operating information to the mobile terminal by means of the touch screen. In some embodiments, the mobile terminal can firstly detect whether a user fingerprint is input in a predetermined location of the touch screen, if yes, then a second fingerprint image corresponding to the user fingerprint is obtained. For example, in a home network, the relevant information of a washing machine is registered in a mobile phone, and a pattern corresponding to the washing machine can be displayed in a certain location on the touch screen of the mobile phone. Now, firstly the mobile phone can detect whether a user fingerprint is input in the location of the pattern on the touch screen, if yes, then it indicates that the user attempts to operate the washing machine by the mobile phone, and the fingerprint image corresponding to the fingerprint input can be obtained. Wherein the predetermined location on the touch screen may be any location on the touch screen, for example, the predetermined location may be in an upper left portion, a lower right portion, an upper right portion, a lower left portion or a central portion of the touch screen.

Wherein the user can set a predetermined direction of a fingerprint image in a mobile terminal, if the moving direction of the second fingerprint image on the touch screen is consistent with the predetermined direction then the authentication is successful, and if not consistent then authentication is unsuccessful.

Wherein the predetermined direction may be from left to right, right to left, up to down, down to up, or along the direction of a diagonal line, broken line or curve line etc.

Wherein the operation instruction may be reading or obtaining the relevant information of the electronic device, starting the electronic device, suspending the electronic device or closing the electronic device and the like. Specifically, the mobile terminal can send the operation instruction to the electronic device via wire communication, preferably via wireless communication.

In the embodiments of the invention, a user is authenticated as follows: firstly a confirmation message that a user has been authenticated sent by a biological recognition device is obtained, and secondly it is determined that the moving direction of a second fingerprint image on a touch screen of the mobile terminal is consistent with a predetermined direction. Thus, a user is authenticated by means of the combination of a biological recognition device and a mobile terminal with a fingerprint image and the moving direction, and the authentication is successful when the two aspects are completed. As compared with the authentication method of the prior art, in the method of controlling an electronic device to operate using a mobile terminal provided by the embodiment of the invention, the user authentication method is more safe, and the course of a mobile terminal controlling the electronic device to operate is more safe.

It is noted that, in some embodiments of the invention, in order to further improve the security of authentication, the mobile terminal shown in FIG. 2 also may comprises a second determining unit (now shown), the second determining unit can be used for determining whether the second fingerprint image is consistent with the preset image.

A user can previously store a preset image in a mobile terminal, and the preset image may be a fingerprint image. When the mobile terminal obtains a second fingerprint image input via the touch screen by a user, the second fingerprint image is compared with the preset image. If the second fingerprint image is consistent with the preset image then the sequent authentication step is performed. If the second fingerprint image is not consistent with the preset image then the authentication process is paused.

By means of the above method, it is avoided that an unauthorized user controls the electronic device to operate by the mobile terminal, thereby further improving the security of authentication.

In some other embodiments, in order to further improve the security of the authentication process, the mobile terminal also comprises a third determining unit (not shown), the third determining unit is used for determining whether the second fingerprint image is moved into the predetermined area, if yes then the authentication is successful, otherwise the authentication is unsuccessful. For example, the predetermined area may be located in the right edge of the touch screen. If the second fingerprint image is moved from an initial location to the right edge of the touch screen then the authentication is successful, otherwise the authentication is unsuccessful.

Furthermore, the mobile terminal shown in FIG. 2 also may comprise a second sending unit (now shown), the second sending unit is used for sending a request message of user identity authentication to the biological recognition device. After receiving the instruction of performing identity authentication on the user, the mobile terminal sends a request message of user identity authentication to the biological recognition device, so that the biological recognition device obtains the first fingerprint image of the user and compares the first fingerprint image with the authenticated image. If consistent, a confirmation message that user identity authentication is successful is generated and sent to the mobile terminal.

In some embodiments, the mobile terminal shown in FIG. 2 also may comprise a wireless communication module, and the wireless communication module may be used for sending an operation instruction to the electronic device. Of course, the wireless communication module can be replaced with a wire communication module, or alternatively the mobile terminal comprises both a wireless communication module and a wire communication module, wherein the wire communication module may be used for sending the operation instruction to the electronic device.

Even the preferable embodiments are described hereinbefore, as long as one skilled in the art knows the concept of basic creativity, some modification and amendments can be made to these embodiments, including embodiments obtained by combining the above embodiments. Thus, the appended claims shall be explained as including preferable embodiments and all the modifications and amendments within the protection scope of the invention.

Obviously, for one skilled in the art, various amendments and variations may be made without departing from the spirit and scope of the invention. Thus, if these amendments and variations belong to the scope of the claims of the invention and equivalent technique thereof, then the invention also is intended to contain these amendments and variations.

What is claimed is:

1. A method of controlling an electronic device to operate using a mobile terminal, comprising:
obtaining a confirmation message that a user has been authenticated sent by a biological recognition device, wherein the confirmation message is generated after the biological recognition device confirms that a first fingerprint image of the user is consistent with an authenticated image;
determining that the moving direction of a second fingerprint image on a touch screen of the mobile terminal is consistent with a predetermined direction; and
sending an operation instruction to the electronic device so that the electronic device operates according to the operation instruction.

2. The method as claimed in claim 1, wherein before determining that the moving direction of the second fingerprint image on the touch screen of the mobile terminal is consistent with the predetermined direction, the method also comprises determining that the second fingerprint image is consistent with a preset image.

3. The method as claimed in claim 1, wherein after determining that the moving direction of the second fingerprint image on the touch screen of the mobile terminal is consistent with the predetermined direction, the method also comprises determining that the second fingerprint image moves into a predetermined area on the touch screen.

4. The method as claimed in claim 1, wherein before obtaining the confirmation message that a user has been authenticated sent by the biological recognition device, the method also comprises sending a request message of user identity authentication to the biological recognition device.

5. The method as claimed in claim 1, wherein sending an operation instruction to the electronic device comprises sending the operation instruction to the electronic device via wireless communication.

6. A mobile terminal, comprising:
an obtaining unit for obtaining a confirmation message that a user has been authenticated sent by a biological recognition device, wherein the confirmation message is generated after the biological recognition device confirms that a first fingerprint image of the user is consistent with an authenticated image;
a first determining unit for determining that the moving direction of a second fingerprint image on a touch screen of the mobile terminal is consistent with a predetermined direction; and
a first sending unit for sending an operation instruction to the electronic device so that the electronic device operates according to the operation instruction.

7. The mobile terminal as claimed in claim 6, wherein the mobile terminal also comprises a second determining unit for determining that the second fingerprint image is consistent with a preset image.

8. The mobile terminal as claimed in claim 6, wherein the mobile terminal also comprises a third determining unit for determining that the second fingerprint image moves into a predetermined area on the touch screen.

9. The mobile terminal as claimed in claim 6, wherein the mobile terminal also comprises a second sending unit for sending a request message of user identity authentication to the biological recognition device.

10. The mobile terminal as claimed in claim 6, wherein the mobile terminal also comprises a wireless communication module for sending an operation instruction to the electronic device.
